(19) United States
(12) Patent Application Publication
(10) Pub. No.: US 2010/0121870 A1
(43) Pub. Date: May 13, 2010

(54) METHODS AND SYSTEMS FOR PROCESSING COMPLEX LANGUAGE TEXT, SUCH AS JAPANESE TEXT, ON A MOBILE DEVICE

(76) Inventors: Erland Unruh, Seattle, WA (US); Kevin Marshall, Kirkland, WA (US); Gordon Waddell, Seattle, WA (US); William H. Steinmetz, Seattle, WA (US); Shu Ishizuki, Seattle, WA (US)

Correspondence Address: PERKINS COIE LLP;PATENT-SEA, P.O. BOX 1247, SEATTLE, WA, 98111-1247, US

(21) Appl. No.: 12/498,338

(22) Filed: Jul. 6, 2009

Related U.S. Application Data
(60) Provisional application No. 61/078,293, filed on Jul. 3, 2008.
(60) Provisional application No. 61/078,299, filed on Jul. 3, 2008.

(51) Int. Cl. G06F 17/30; G06F 17/20

(52) U.S. Cl. 707/769; 704/8; 707/E17.014; 707/E17.033

(57) ABSTRACT

A system and method to search for items characterized by Japanese text using a mobile device. The search system receives keyed user input and converts the input into a set of search terms. After generating search terms, the system searches Japanese text fields for matching items accessible by the mobile device. One or more natural starting points in the text fields are identified for each matching item. Starting points may include, for example, the beginning of a text field and the locations of punctuation or changes in character set in the text field. After determining starting points, the system determines the distance between the matching text and a starting point. The system then provides an ordered set of search results based on the calculated distance and potentially other factors, such as the alignment of the match and the type of item.

### CROSS-REFERENCE TO RELATED APPLICATION(S)

This application claims the benefit of U.S. Provisional Application No. 61/078,293, entitled “IMPROVED METHOD FOR SEARCHING JAPANESE TEXT USING A MOBILE DEVICE,” and U.S. Provisional Application No. 61/078,299, entitled “IMPROVED METHOD OF WORD SELECTION FOR JAPANESE TEXT ENTRY ON A MOBILE DEVICE,” both filed on Jul. 3, 2008.

### BACKGROUND

Written Japanese is generally a combination of characters from several different character sets. In particular, Japanese uses a logographic writing system, two distinct alphabets for phonetic text, as well as Latin letters, Arabic numerals, and other symbols imported from other languages. Two of the native alphabets, called hiragana and katakana, use letters (called kana) to represent syllables. Hiragana and katakana include approximately 90 letters in total. The character set called kanji consists of thousands of logographic characters that represent words or parts of words.

FIG. 1 illustrates three primary systems for representing Japanese text. In general, Japanese is written in midashigo, examples of which are shown in the right column of FIG. 1. Midashigo refers to text having characters from any of the alphabets described above, including kanji, kana, Latin letters, Arabic numerals, symbols, and punctuation. Japanese text typically does not use spaces to delimit word boundaries.

Kanji encompasses an extremely large character set, on the order of tens of thousands of characters. Therefore, systems for entering Japanese text to a computing device generally receive Latin letters (called romaji) or kana as input and convert the input into midashigo. As shown in the left column of FIG. 1, romaji is a phonetic representation of the Japanese language using Latin characters. Because Japanese written in romaji is difficult to read, romaji is generally used only for input. For example, romaji is typically used on keyboards having a QWERTY layout.

The middle column of FIG. 1 shows examples of yomi, which is the Japanese term for “reading.” Yomi refers to a phonetic representation of the Japanese text using the kana alphabets. Kana is commonly used on mobile devices having 12-key keypads, but may also be used to enter text using a QWERTY keyboard. In a 12-key layout, the keypad usually features five kana per key. A user can select a particular character from the five kana by tapping the selected key multiple times until the desired kana is displayed. For example, the yomi displayed in the middle column of FIG. 1 contains five distinct kana that could be input by five different sets of key presses.

Systems for entering Japanese text provide conversion engines to convert between romaji, yomi, and midashigo. In general, there may be many different romaji that convert to a single yomi. However, input systems can easily convert from romaji to yomi because transliteration methods for romaji to yomi are fairly well-defined. For example, the left set of arrows of FIG. 1 show that the three romaji words in the left column map to a single yomi in the center column. Some input systems are able to correct common user errors in romaji using disambiguation methods such as frequency analysis.

In contrast, there is a many-to-many relationship between yomi and midashigo. As shown by the arrows from the middle column of FIG. 1 to the right column of FIG. 1, the yomi in the center column can be converted into at least five different midashigo. The possible midashigo include characters from several character sets, including kana, kanji, and Arabic numerals. In addition, FIG. 1 shows that three possible yomi can map to the single midashigo at the bottom of the right column. In general, for one yomi there will be at least 2-4 midashigo that may match, although there could be dozens of potential matches.

The complexity of written Japanese is particularly challenging when used on a mobile device, such as a cellular phone, smartphone, portable media player, portable email device, portable gaming device, etc., because these devices often use numerical keypads or reduced keyboards for user input. Entering Japanese text using these input components is complex and can be very time consuming. Searching for text using these input methods can be similarly challenging. Thus, it would be useful to have a system that could simplify the process of entering Japanese text in a mobile device and searching for particular text on the mobile device.

### BRIEF DESCRIPTION OF THE DRAWINGS

FIG. 1 illustrates prior art techniques for representing Japanese text.

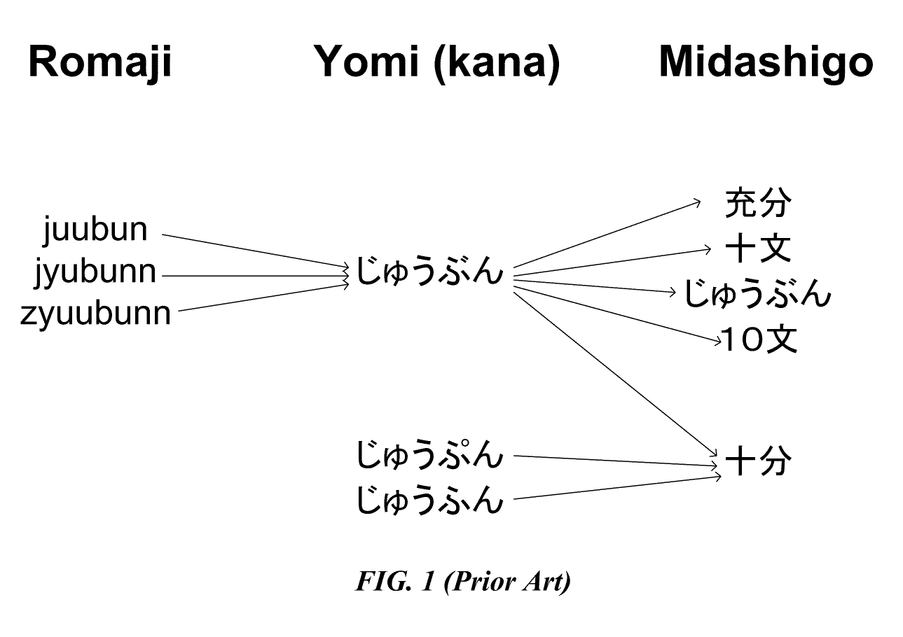

FIG. 2 is a front view of a mobile device suitable for processing Japanese text.

FIG. 3 is a network diagram of a representative environment in which a mobile device operates.

FIG. 4 is a high-level block diagram showing an example architecture of a mobile device.

FIG. 5 is a chart that depicts three stages of Japanese language text input using a predictive text entry system.

FIG. 6 is a representative user interface that depicts the results of the predictive text entry system using a single list of midashigo.

FIG. 7 is a logical block diagram of the predictive text entry system for the Japanese language.

FIG. 8 is a flowchart of a process executed by the predictive text entry system.

FIG. 9 is a representative user interface that depicts the results of a search on a mobile device by a search system configured to search Japanese text.

FIG. 10 is a logical block diagram of the search system for searching Japanese text on a mobile device.

FIG. 11 is a flowchart of a process executed by the search system.

### DETAILED DESCRIPTION

Methods and systems for processing complex language text, such as Japanese text, are disclosed herein. The following detailed description provides specific details for a thorough understanding and an enabling description of various embodiments of the invention. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### 1. Representative Mobile Devices and Wireless Environments

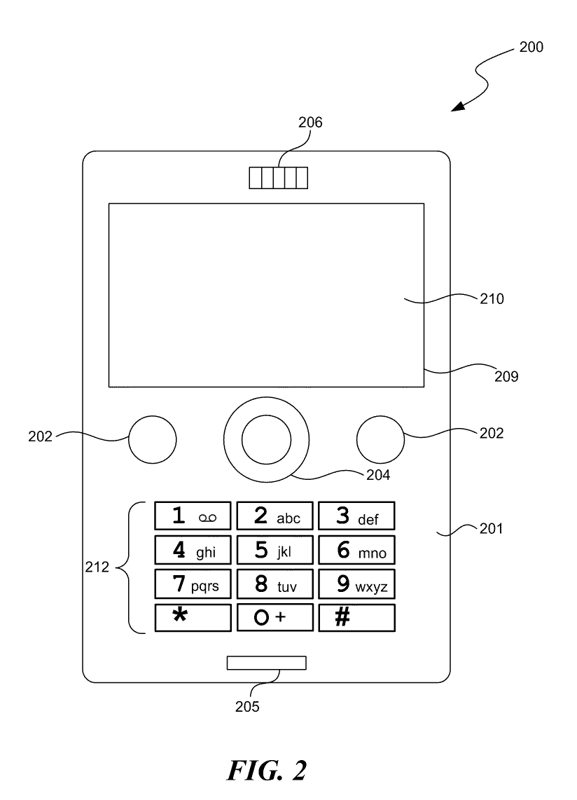

FIG. 2 is a front view of a mobile device 200 suitable for processing Japanese text. As shown in FIG. 2, the mobile device 200 may include a housing 201, a plurality of push buttons 202, a directional keypad 204 (e.g., a five-way key), a microphone 205, a speaker 206, and a display 210 carried by the housing 201. The mobile device 200 may also include other microphones, transceivers, photo sensors, and/or other computing components generally found in PDA phones, cellular phones, smartphones, portable media players, portable gaming devices, portable email devices (e.g., Blackberrys), or other mobile communication devices.

The display 210 includes a liquid-crystal display (LCD), an electronic ink display, and/or other suitable types of display configured to present a user interface. The mobile device 200 may also include a touch sensing component 209 configured to receive input from a user. For example, the touch sensing component 209 may include a resistive, capacitive, infrared, surface acoustic wave (SAW), and/or another type of touch screen. The touch sensing component 209 may be integrated with the display 210 or may be independent from the display 210. In the illustrated embodiment, the touch sensing component 209 and the display 210 have generally similar sized access areas. In other embodiments, the touch sensing component 209 and the display 210 may have different sized access areas. For example, the touch sensing component 209 may have an access area that extends beyond a boundary of the display 210. The mobile device 200 also includes a 12-key numerical keypad 212 capable of receiving text or numerical input from a user. Alternatively, the mobile device 200 may include a full QWERTY keyboard for receiving user input. Instead of, or in addition to, a hardware keypad or keyboard, the mobile device 200 may also provide a software keyboard or keypad on the display 210 to enable a user to provide text or numerical input through the touch-sensing component 209.

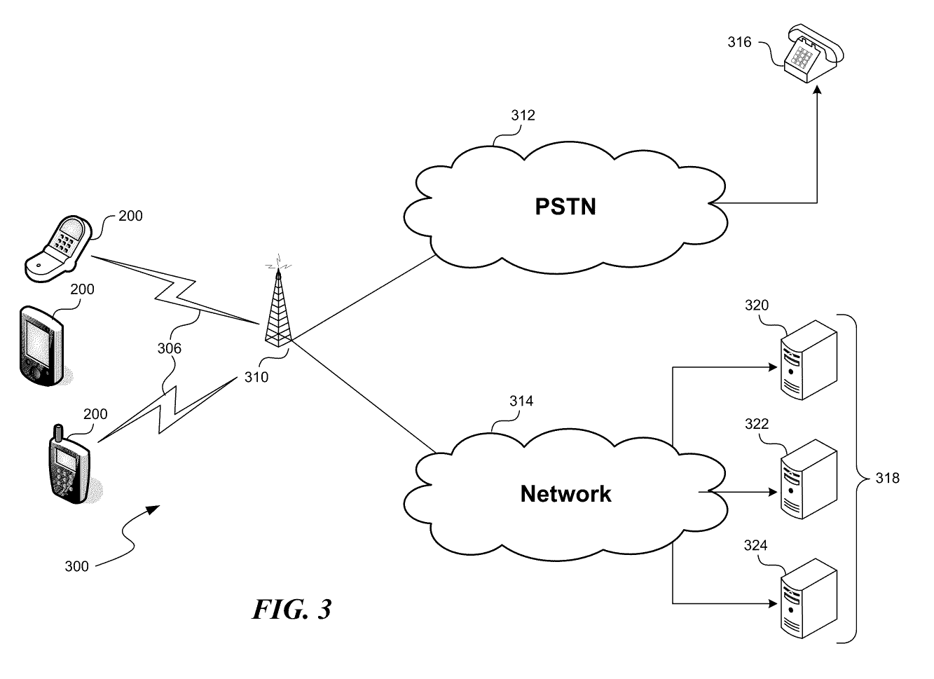

FIG. 3 is a network diagram of a representative environment 300 in which a mobile device operates. A plurality of mobile devices 200 roam in an area covered by a wireless network. The mobile devices are, for example, cellular phones, PDA phones, smartphones, portable media players, portable gaming devices, portable email devices (e.g., Blackberrys) or other mobile Internet devices. The mobile devices 200 communicate to a transceiver 310 through wireless connections 306. The wireless connections 306 could be implemented using any wireless protocols for transmitting digital data. For example, the connection could use a cellular network protocol such as GSM, UMTS, or CDMA2000 or a non-cellular network protocol such as WiMax (IEEE 802.16), WiFi (IEEE 802.11) or Bluetooth. Although wireless connections are most common for these mobile devices, the devices may also communicate using a wired connection such as Ethernet.

The transceiver 310 is connected to one or more networks that provide backhaul service for the wireless network. For example, the transceiver 310 may be connected to the Public-Switched Telephone Network (PSTN) 312, which provides a connection between the mobile network and a remote telephone 316. When the user of the mobile device 200 makes a voice telephone call, the transceiver 310 routes the call through the wireless network's voice backhaul (not shown) to the PSTN 312. The PSTN 312 then automatically connects the call to the remote telephone 316. If the remote telephone 316 is another mobile device, the call is routed through a second wireless network backhaul to another transceiver.

The transceiver 310 is also connected to one or more packet-based networks 314, which provide a packet-based connection to remote services 318 or other devices. Data transmitted from the mobile device 200 to the transceiver 310 is routed through the wireless network's data backhaul (not shown) to the packet-based network 314 (e.g., the Internet). The packet-based network 314 connects the wireless network to remote services 318, such as an e-mail server 320, a web server 322, and an instant messenger server 324. Of course, the remote services 318 may include any other application available over the Internet or other network, such as a file transfer protocol (FTP) server or a streaming media server.

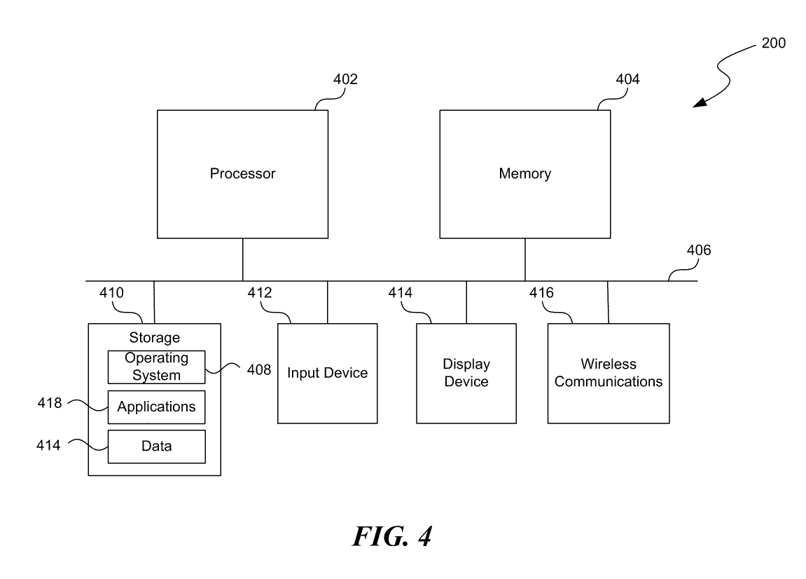

FIG. 4 is a high-level block diagram showing an example architecture of a mobile device 200. The mobile device 200 includes processor(s) 402 and a memory 404 coupled to an interconnect 406. The interconnect 406 shown in FIG. 4 is an abstraction that represents any one or more separate physical buses, point-to-point connections, or both, connected by appropriate bridges, adapters, or controllers. The processor(s) 402 may include central processing units (CPUs) of the mobile device 200 and, thus, control the overall operation of the mobile device 200 by executing software or firmware. The processor(s) 402 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 404 represents any form of fixed or removable random access memory (RAM), read-only memory (ROM), flash memory, or the like, or a combination of such devices. The software or firmware executed by the processor(s) may be stored in a storage area 410 and/or in memory 404, and typically include an operating system 408 as well as one or more applications 418. Data 414 utilized by the software or operating system is also stored in the storage area or memory. The storage area 410 may be a flash memory, hard drive, or other mass-storage device.

The mobile device 200 includes an input device 412, which enables a user to control the device. The input device 412 may include a keyboard, trackpad, touch-sensitive screen, or other standard electronic input device. The mobile device 200 also includes a display device 414 suitable for displaying a user interface, such as the display 210 (FIG. 2). A wireless communications module 416 provides the mobile device 200 with the ability to communicate with remote devices over a network using a short range or long range wireless protocol.

### 2. Predictive Text Entry

A system and method for providing predictive text entry for Japanese language mobile devices is disclosed (hereinafter referred to as “the text entry system” or “the system”). As will be described in greater detail, for a user of a Japanese language mobile device having a numerical keypad, text entry is generally a two step process. In the first step, the mobile device converts user input into one or more yomi, which are displayed to the user. In the second step, the mobile device displays a list of midashigo corresponding to the selected yomi. The user then selects the desired midashigo from the second list. The text entry system disclosed herein compresses this process to a single step. After receiving user input, the text entry system determines all yomi corresponding to the received input. The text entry system then determines a set of matching midashigo corresponding to all of the possible yomi and displays some or all of the set of midashigo to the user. The text entry system may group the midashigo according to the corresponding yomi. Alternatively, the system may display the midashigo in an order based on a prediction of which midashigo the user is more likely to select, so that likely matches are displayed earlier in the list than less likely matches. The system may also be configured to display only the most likely midashigo and hide the less likely results.

In the explicit romaji method for entering Japanese text to a computer system, a user enters Japanese using romaji on a QWERTY keyboard. The system then automatically converts the romaji to kana, after which a conversion engine may automatically convert the kana into midashigo. In the explicit yomi entry method, the user selects individual kana on a QWERTY keyboard that features the approximately 50 characters of a kana alphabet. The explicit yomi method is rare on telephones, but is common on other consumer electronics devices. On a mobile telephone or other device having a reduced keypad, a user may enter text using the multi-tap method discussed above. In that case, the user taps a single key one to five times per kana to iterate across a list of kana in order to enter the desired kana. For each of these methods, the system displays a list of probable midashigo conversions for the entered kana. The user can then select the desired midashigo from the list.

Users may also enter text using a predictive entry system, such as a T9 system licensed from Nuance Communications of Burlington, Mass. Predictive entry systems simplify input by predicting full words based on partial inputs. Mobile devices with a 12-key keypad (such as a mobile device) may support a T9 system for the Japanese language in addition to the multi-tap method. When using a predictive entry system, the user enters one key per kana in the yomi. The Japanese T9 engine uses a combination of word lists and grammar to conjugate or combine matching yomi. In the process, it attempts to predict the desired midashigo. However, the conversion process may generate multiple possibilities, resulting in ambiguity. In cases where there are many possible matches, the user selects the desired yomi and then must select the desired midashigo to match the selected yomi.

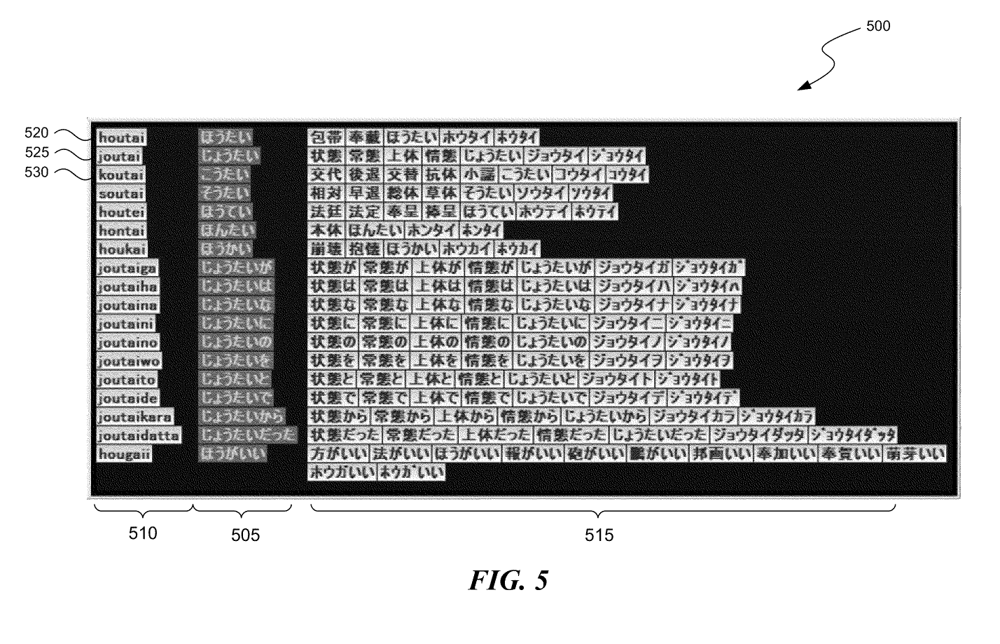

FIG. 5 is a chart 500 that depicts representative textual data such as used in the two-step process of Japanese language text input using a T9 system and as used in the one-step process of the text entry system disclosed herein. Column 505 of FIG. 5 shows an example list of yomi that are generated as a result of a specific set of key presses. As noted above, the yomi are generated using a combination of word lists and grammar to predict possible matches. Some yomi may be generated using spelling correction or word completion, i.e., spelling correction may be used to correct for mistakenly entered characters and word completion may be used to provide a full word based on its initial characters. The list of yomi may also be configured to correct for regional differences in spelling by generating the standard Japanese spelling of a word from its regional spelling. The yomi on the list may be ordered according to the likelihood that the yomi matches the user's input. That is, the first yomi in column 505 may be the statistically most probable match for a user's input and the last yomi in column 505 may be the least probable match for a user's input. Column 510 of FIG. 5 shows the romaji equivalent to the generated yomi, while column 515 displays midashigo that are associated with the yomi. As shown in FIG. 5, a particular yomi has a varying number of possible matching midashigo. As with the yomi list, the midashigo may also be ordered according to the likelihood that each midashigo will be selected. That is, the first midashigo in each list in column 515 may be the statistically most probable match for a user's input and the last midashigo in each list in column 515 may be the least probable match for a user's input.

Using the two-step process of the T9 system, a user entering Japanese text would initially be presented with a list of yomi selected from column 505. Once the user has selected a yomi from the displayed choices, the T9 system would display a list of the midashigo (as contained in column 515) that are associated with the selected yomi. The user then selects the desired midashigo from the displayed choices. A problem with a user first selecting a yomi before selecting a midashigo is that it requires the user to complete two steps in order to input the desired midashigo. The two-step process can be time-consuming if the user intends to enter a long message. It would therefore be useful to provide a method for entering Japanese text that reduces the number of actions required to enter the desired text.

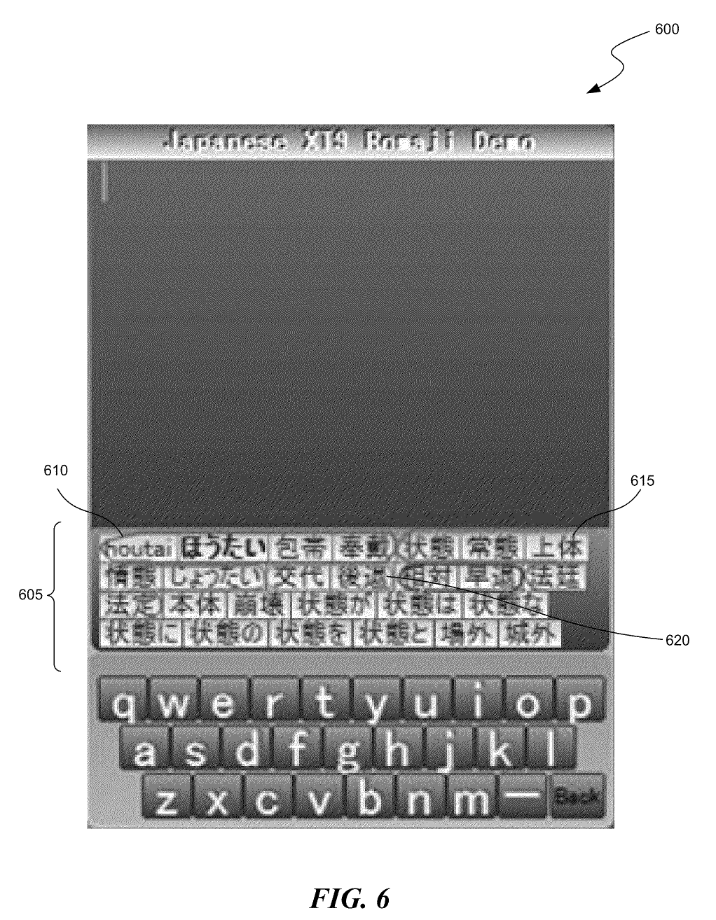

FIG. 6 is a representative user interface 600 that depicts the results of a predictive text entry system using a single list of midashigo. In the depicted interface 600, the two-step process discussed with respect to the T9 system is collapsed into a one-step process by the use of a single combined list that is displayed to a user. As shown in FIG. 6, a single list 605 of midashigo is displayed by the text entry system to the user. Sets of midashigo are grouped by their corresponding yomi (the grouped sets of midashigo are circled in the figure for clarity). Thus, the first four possibilities depicted in the interface (as reflected in circled set 610) are associated with the romaji “houtai.” The next five midashigo (as reflected in circled set 615) are associated with the romaji “joutai,” and the next two midashigo (as reflected in circled set 620) are associated with the romaji “koutai.” Additional groupings of midashigo follow in the list 605, from left to right across the display screen. Using the depicted interface, a user may select a desired midashigo from the displayed list without having to first select a corresponding yomi.

While a single list is displayed horizontally in FIG. 6, it will be appreciated that the list may be displayed vertically or may have a scrolling feature to allow a user to scroll through the combined list. For example, each set may be displayed on a different line on the display, and the user may be allowed to scroll within the set list.

For each group of displayed midashigo, the text entry system may display all corresponding midashigo or a subset of the corresponding midashigo. For example, the contents of set 610 are selected from row 520 of the chart 500. Set 610 contains two of the associated midashigo that are selected from column 515. The contents of set 615 are selected from row 525 of chart 500. Set 615 contains four of the midashigo as selected from column 515 that are associated with the romaji “joutai.” The contents of set 620 are selected from row 530 of chart 500. Set 615 contains two of the midashigo as selected from column 515. As a cue to the user, the text entry system may also display the most likely romaji and/or yomi. For example, set 610 contains the romaji “houtai” selected from column 510 followed by the associated yomi selected from column 505.

When a subset of the available midashigo is displayed, the text entry system may select the subset based on the likelihood that a displayed midashigo will be selected by the user. The combined list may also display some or all available midashigo in a priority order based on likelihood of being selected. For example, the text entry system may generate the combined list 605 by placing likely matches at the beginning of the list (grouped by yomi) and placing remaining matches at the end (grouped by likelihood of selection across all yomi). Alternatively, the text entry system may display likely matches based on the full list of possible midashigo (i.e., including words included based on spell correction, regional correction, or word completion), but only display remaining midashigo having yomi that exactly match the user's input.

The midashigo displayed in the combined list may be ordered based on a number of factors, including (in no particular order):
the index in the yomi list (e.g., the system might display more midashigo for a yomi that is more likely to match the user's input);
the index in the midashigo list (e.g., the system might display a limited number of midashigo associated with any particular yomi);
whether the key sequence is valid romaji;
whether the yomi is in a word list (e.g., the system might not display midashigo for yomi that are not found in the system's word list or dictionary);
whether the yomi was generated based on regional correction;
whether the yomi was generated based on spell correction;
whether the yomi was generated based on word completion.
   To generate the combined list 605, the system may assign a numerical value to one or more of the above factors for each available midashigo. The numerical value may be based on whether each factor is satisfied or not by the midashigo, or the numerical value may be based on the actual value of the factor for the midashigo (e.g. in the case of factors based on an index value). Each factor may be weighted in accordance with the perceived importance of the factor, and an overall relevance score for each midashigo calculated by summing the weighted numerical values of all associated factors. The system may then determine likely midashigo for the combined list by comparing the relevance score to a threshold relevance value. The system displays the combined list with the likely midashigo in groups according to their yomi (as shown in FIG. 6). As noted above, remaining midashigo may then be displayed in the combined list after the likely midashigo are displayed. Alternatively, the items in the combined list may be ordered (i.e., ranked) by overall relevance score.

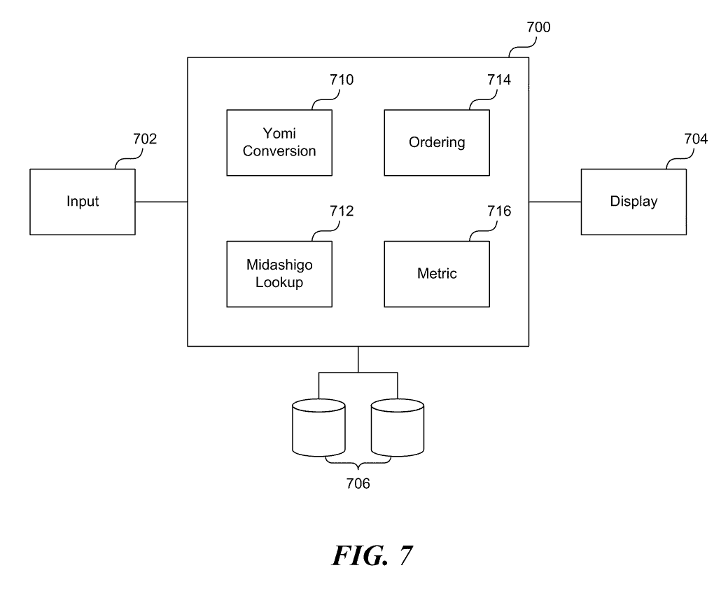

FIG. 7 is a logical block diagram of a text entry system 700 which may be implemented on a mobile device 200. Aspects of the system may be implemented as special-purpose hardware circuitry, programmable circuitry, or a combination of these. As will be discussed in additional detail herein, the text entry system 700 includes a number of modules to facilitate the functions of the system. Although the various modules are described as residing in a single device, the modules are not necessarily physically collocated. In some embodiments, the various modules could be distributed over multiple physical devices and the functionality implemented by the modules may be provided by calls to remote services. Similarly, the data structures could be stored in mobile storage or remote storage, and distributed in one or more physical devices. Assuming a programmable implementation, the code to support the functionality of this system may be stored on a computer-readable medium such as an optical drive, flash memory, or a hard drive. One skilled in the art will appreciate that at least some of these individual components and subcomponents may be implemented using application specific integrated circuits (ASICs), programmable logic devices (PLDs), or a general-purpose processor configured with software and/or firmware.

As shown in FIG. 7, the text entry system 700 receives user input via an input component 702, such as the keypad 212 shown in FIG. 2. As discussed above, the keyboard or keypad may be implemented as a hardware keypad 212 or as a displayed keypad used via the touch-sensing component 209. The text entry system 700 outputs an ordered list of midashigo to a user via a display component 704, such as the display 210. The system 700 may access a storage component 706, which is configured to store configuration and data related to the operation of the text entry system.

The text entry system 700 includes a yomi conversion component 710, which is configured to receive user keystrokes from the input component 702 and determine a set of possible yomi conversions based on the received keystrokes. The set of possible yomi conversions may be determined using a yomi lookup table stored in the storage component 706 to translate the received keystrokes to the set of possible yomi. The text entry system 700 also includes a midashigo lookup component 712, which is configured to determine a list of midashigo corresponding to the set of possible yomi generated by the yomi conversion component 710. To do so, the midashigo lookup component 712 may use one or more dictionaries stored in the storage component 706. The midashigo lookup component may also perform spelling correction and regional correction in order to generate the list of midashigo. Thus, the midashigo lookup component 712 may search for close matches to each yomi in addition to determining exact matches.

The text entry system 700 also includes an ordering component 714, which is configured to determine an ordering or grouping of the list of midashigo for display to a user. To do so, the ordering component 714 interacts with a metric component 716, which is configured to evaluate the factors discussed above (e.g., index in the yomi list, index in the midashigo list, etc.) to determine a relevance score for each of the midashigo. The ordering component 716 then generates the ordered list of midashigo based on the relevance scores. The ordering component 716 may limit the number of midashigo that are provided to the display component 704, so that only the most relevant midashigo are displayed.

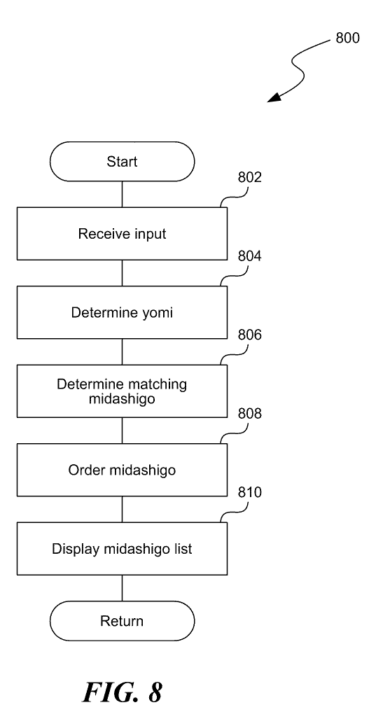

FIG. 8 is a flowchart of a process 800 executed by the text entry system 700. Processing begins at block 802, where the text entry system receives input from the input component 702. The input may be in the form of one or more ambiguous keystrokes. At block 804, the text entry system determines a set of yomi corresponding to the received keystrokes. When determining the set of yomi, the system may attempt to perform spelling correction by determining yomi corresponding to similar, but not identical, input sequences. The system may also determine yomi by predicting possible words that begin with the input sequence.

Processing then proceeds to block 806, where the text entry system identifies a set of midashigo that match the yomi determined in step 804. As discussed above, the system may determine matching midashigo by searching in one or more dictionaries that are indexed based on yomi. In some embodiments, the set of midashigo includes only midashigo that correspond exactly to the yomi being used for the search. In other embodiments, the system also retrieves midashigo that begin with or include the particular yomi.

Processing then proceeds to block 808, where the system determines an order for the set of midashigo. As discussed above, the system may calculate a relevance score for each of the midashigo in order to rank the relevance of the midashigo. Midashigo having the highest relevance scores may be promoted in the list, and midashigo having the lowest relevance scores may be demoted in the list. The system then proceeds to block 810, where it displays the ordered midashigo list to a user. The user is thereby able to quickly and easily select a desired midashigo with a minimal amount of effort.

### 3. Text Searching

In addition to entering Japanese text on a mobile device, a user may also want to search and find particular text on the mobile device. To allow a user to more easily locate particular text, a system and method for searching for Japanese text via a mobile device is disclosed (hereinafter referred to as “the search system” or “the system”). The search system receives user input through a keypad or keyboard on a mobile device and converts the input into a set of search terms. In some embodiments, the system uses the text entry system discussed above to convert the input to midashigo. However, instead of providing a list of midashigo to a user to select a particular sequence, the system uses the generated list as a set of search terms. After generating the search terms, the system searches text fields in items accessible by the mobile device to find matching items. The system then determines one or more natural starting points in the text fields of each matching item. As discussed in greater detail below, starting points may include the beginning of the text field and the locations of punctuation or changes in character set. After determining starting points, the system determines the distance between the matching text for each matching item and a natural starting point. The system then provides an ordered set of search results based on the calculated distance and on other factors, such as the alignment of the match, the type of item, and the number of times the item has previously been used. In some embodiments, the system uses multiple search terms to generate a list of results. The ordering is then determined by combining the distances and other factors for each of the multiple search terms.

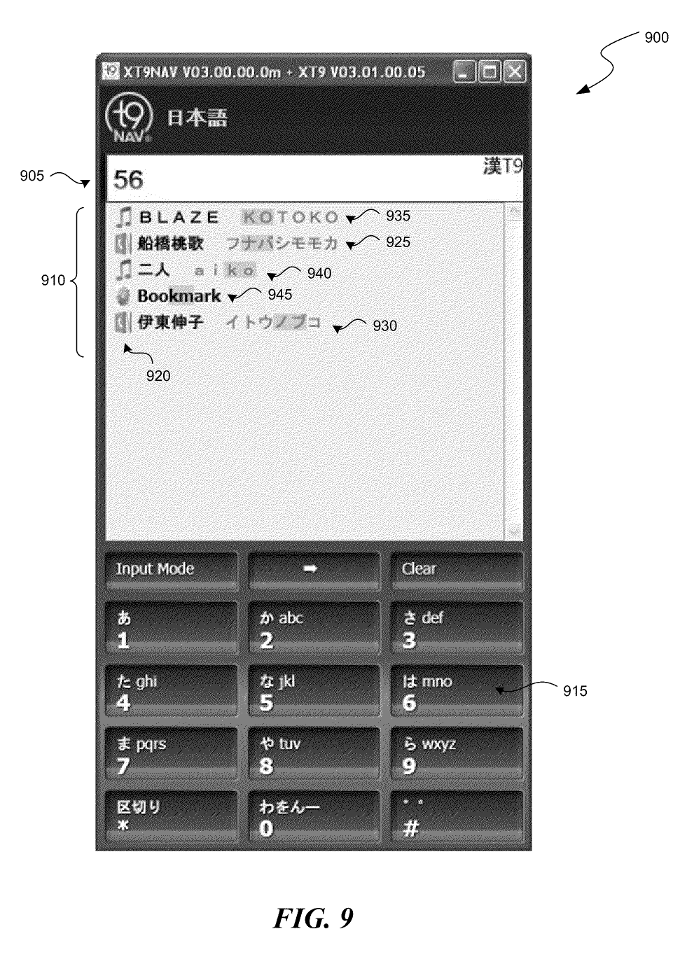

FIG. 9 is a representative user interface 900 depicting the results of a search on a mobile device by a search system configured to search Japanese text. The search system may be used to find items accessible by the mobile device. These items may be stored locally on the mobile device or in remote storage accessible through a network connection. As used herein, “items” are data objects associated with the mobile device, such as device features, applications, or data (including address book entries, files, documents, media files such as music files, image files, video files, etc.). Individual items may have one or more text fields that may be used for searching. As used herein, a “text field” is a space allocated for storing a particular piece of text information. For example, a music file may have multiple text fields for storing title, artist, or album. Similarly, an address book entry may have multiple text fields for storing name, telephone number, or e-mail address. A text field may be stored as part of a file or in a separate index.

In the example shown in FIG. 9, the user has selected keys “5” and “6” on the mobile device. The selection of the keys is reflected by the display “56” in a text entry region 905. By selecting the “5” and “6” keys, the user has directed the search system to search for character combinations associated with the “5” and “6” keys. The characters associated with each key are reflected on the key at a location 915 above the number on the key. The characters associated with the “5” and “6” keys therefore include “ko,” “km,” and various kana inputs, such as the second item highlighted on the list. As shown in a results region 910 on the user interface, the search system has returned five matching items with the matched character combinations highlighted in the displayed items. The five items contain various types of Japanese characters, as well as Latin letters. Each item is identified by a preceding icon 920, which indicates the type of item. Items 925 and 930 on the screen are names from an address book. The characters on the right of these items show the yomi for the kanji characters on the left. Items 935 and 940 are music files, and item 945 is a device feature (e.g., a bookmark) that can be used by the user. As depicted in FIG. 9, the matches for the two characters may be found at any location within each search result.

The structure of the Japanese language poses additional challenges in searching Japanese text. For example, in addition to using multiple alphabets, Japanese text often lacks spaces or other indicators of the end of one word and the beginning of another. The search system disclosed herein improves matching and presentation of search results by segmenting the text being searched to find natural starting points for words, sentences, or groups. The system then ranks matches that occur at natural starting points higher than matches that occur further away.

For English text, natural starting points are generally located at the beginning of a sentence, after whitespace, or after a punctuation mark. For Japanese text, the search system uses one or more of the following techniques to identify natural starting points:
In Japanese writing, specialized algorithms that use word lists and grammar rules (called “segmentation engines”) can be used to infer natural starting points.
Simple patterns can be used to identify natural starting points, such as punctuation marks, or a shift between two alphabets (e.g. between a kana alphabet and kanji or between kanji and Arabic numerals). For example, there is a comma in the phrase [symbol] [symbol] that explicitly separates the words “Canned Beer” [symbol] and “Takoyaki” [symbol] . The use of simple patterns to identify natural starting points can only identify a subset of all the natural starting points that may be present in a Japanese sentence, but it is less costly to implement on a mobile device with limited computational resources.
Telephone numbers provide another example of natural starting points. Telephone numbers have predefined formats in each country, which the search system can use to determine starting points. For example, for a United States telephone number such as (206) 234-5678, characters in the phone number that are not digits could be used to determine natural starting points. Thus, although searches for “234” and “456” would both match to the telephone number, the match would be considered more significant for the “234” search because it occurs at a natural starting point in the number.

Once a set of matches have been found, the search system returns the set of matches and uses various factors to determine the order of the search results. For example, the system may be configured to display matched items in order of distance from a natural starting point. This ordering methodology was used by the system to generate the search results shown in FIG. 9. In item 935 of FIG. 9, the input search term matched the characters at the beginning of a word—i.e. a distance of zero from a natural starting point. The second matched item (item 925) has a distance of one character from the natural starting point at the beginning of the word. Similarly, the third, fourth, and fifth items (items 940, 945, and 930, respectively) have distances of two, three, and four characters, respectively, from a natural starting point. By ordering the search results in accordance with distance of the matching characters from a natural starting point in a matching character string, the search system disclosed herein is able to present potentially more relevant search results to a user at the top of the search results list.

In addition to distance from a natural starting point, the system may take into account other factors when ordering search results, including (in no particular order):
whether the match is aligned with the start of a field (e.g., the system might consider a match at the start of the field to be more relevant than a match at a natural starting point within the field.);
whether the match is aligned with the start of a word;
the type of item matched (e.g., whether the item is a phone number or a song title);
if any of the matches are in the primary field or in the secondary field (e.g. the system might consider a match to a contact's given name to be more relevant than a match to a company name or city);
whether the search term matched all of the text between a natural starting point and the next adjacent natural starting point, or only part of the text between the starting points;
whether the matched item has been used before (i.e., whether the matched item was selected by a user from previous search results); and/or
the number of times that the matched item has been used (i.e., the number of times that the matched item was selected by a user from previous search results).
   To determine the order of the search results, for each item in the search results the search system may assign a numerical value to one or more of the above factors based on whether each factor is satisfied or not by the search result. Each factor may be weighted in accordance with the perceived importance of the factor, and an overall relevance score for each item calculated by summing the weighted numerical values of all associated factors. The items in the search results are then listed (i.e., ranked) by overall relevance score.

The system may also be capable of searching using multiple search terms simultaneously. In a multi-term search, the system may be configured to combine the weighted factors and sort based on that combined score. The combined score can be computed using a number of methods, such as a summation of the search term scores, multiplying the weighted probabilities (or as a summation of logarithms), or using comparators with specialized conditional logic. As an example of using specialized comparators, consider a search for two terms that returns two results. For the first result, both terms are one character away from a natural starting point. For the second result, one term is aligned with a natural starting point and the other is three characters away from a natural starting point. If the system is configured to rank results solely based on distance from a natural starting point, it would rank the first result before the second because the first has a smaller sum of distances than the second. If the system is instead configured to prioritize alignment, it would rank the second result before the first because one of the terms was aligned with a starting point.

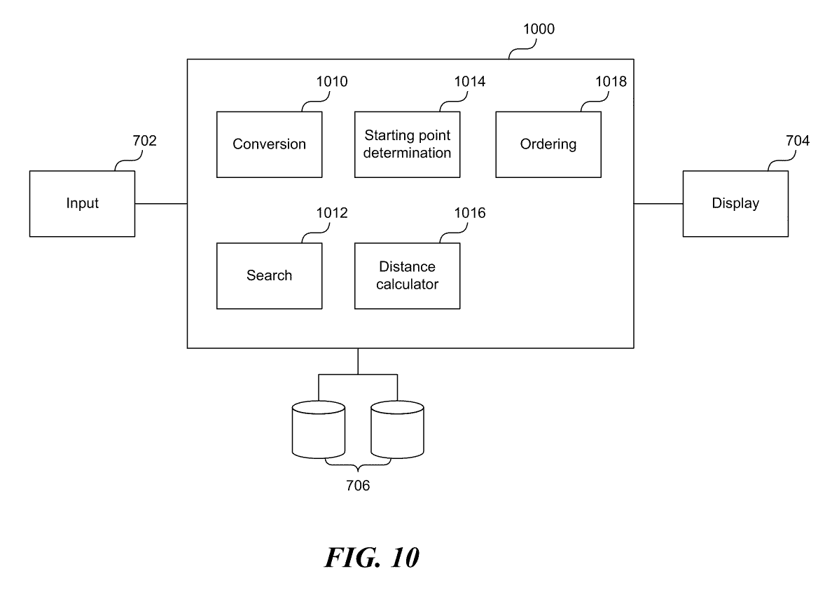

FIG. 10 is a logical block diagram of a search system 1000 for searching Japanese text on a mobile device. The system 1000 receives user input via an input component 702, outputs an ordered list of search results via a display component 704, and stores and retrieves data from a storage component 706. Each of these components corresponds in operation to the components discussed above for FIG. 7. The storage component 706, in addition to including dictionaries to be used for converting user input into Japanese, may also include a database or index of items stored on the mobile device. As stated above, these items may be, for example, audio files, video files, address book entries, bookmarks, or other applications, functions, or data files, and have one or more text fields that can be searched by the search system.

The search system 1000 includes a conversion component 1010, which is configured to convert user input (received from the input component 702) into a set of midashigo search terms. The conversion component 1010 may use a process similar to that of the text entry system discussed above to generate the set of search terms. Generally, the list of search terms includes all midashigo that correspond to the user input.

The search system 1000 also includes a search component 1012, which is configured to search the mobile device or remote locations accessible by the mobile device based on the search terms generated by the conversion component 1010. Searching may include searching a previously generated database or index of items stored by the storage component 706. In general, the search component 1012 searches for matching text (i.e., occurrences of the search terms) anywhere within the text fields of the items on the mobile device. The search component 1012 then generates a list of matching items corresponding to the search terms.

The search system 1000 also includes a starting point determination component 1014, which is configured to process each of the search results to determine one or more natural starting points within the item's text fields. As discussed above, the system may use various methods to determine starting points, such as detecting punctuation or transitions in character sets within the text. The starting point information is then used by a distance calculator component 1016, which is configured to determine a distance for each matching text from a natural starting point. In some embodiments, the distance is equal to the number of characters between the start of the matching text and the nearest starting point occurring prior to the start of the matching text. In other embodiments, the distance is the number of characters to the nearest starting point in either direction from the start of the matching text. The calculated distance is used by an ordering component 1018, which is configured to order the search results based on the calculated distance and to provide the ordered search results to a user via the display component 704. The ordering component 1018 may also use the additional factors discussed above to determine the order for the search results.

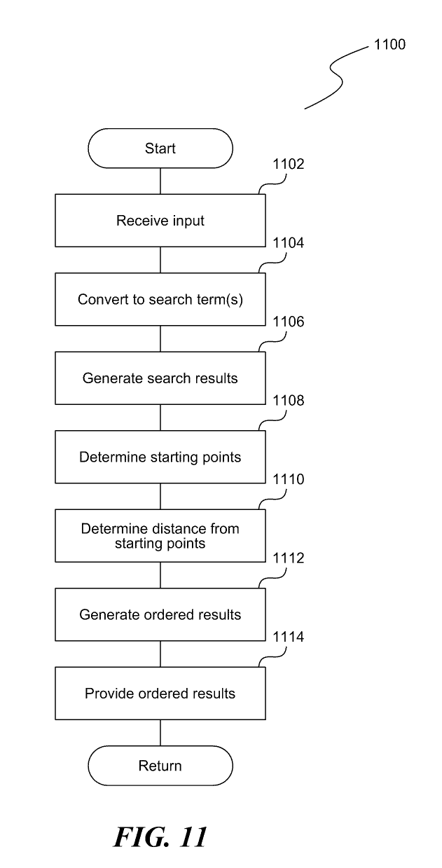

FIG. 11 is a flowchart of a process 1100 executed by the search system 1000. Processing begins in block 1102, where the system receives user input. The user input may be provided through a hardware keypad or keyboard or through a software-displayed keypad or keyboard. At block 1104, the search system converts the user input to one or more text search terms. The conversion of user input to text search terms may be done using a process similar to the predictive text entry method disclosed above. That is, the search system may convert the received input into one or more yomi and use the yomi to determine a set of corresponding midashigo. The set of midashigo corresponding to all possible yomi is then used as a set of search terms by the search system.

After determining a set of search terms, processing proceeds to block 1106, where the search system generates a set of search results corresponding to the determined set of search terms. In some implementations, the system directly searches the mobile device and associated remote locations at the time of the search to find matching items. In other implementations, the system uses a database or other previously generated index of items to perform the search. The index includes information about each item, such as the contents of one or more text fields associated with the item. For example, the system may rely upon an index that stores title or description information for media files stored on the mobile device or in remote locations accessible by the mobile device.

Processing then proceeds to block 1108, where the search system uses the methods discussed above to determine one or more natural starting points within the text fields of each of the matching items. At block 1110, the search system determines a distance between the matching text for each matching item and a starting point as discussed above. At block 1112, the search system generates a set of ordered search results using the calculated distances and the other factors discussed above. At block 1114, the system provides the ordered results for display to a user. By presenting the search results to the user in an order dependent on natural starting points within the matched text, the user is able to quickly and easily locate desired items on or accessible via the mobile device.

Although the text entry and search systems are described above in the context of the Japanese language, the systems are not so limited. One skilled in the art will appreciate that similar systems could be used for text entry and search in other languages that use complex characters for their writing, such as Chinese or Korean. In particular, the systems could be useful for Korean, which often includes text in a combination of kanji and hangul (Korean alphabet).

From the foregoing, it will be appreciated that specific embodiments of the invention have been described herein for purposes of illustration, but that various modifications may be made without deviating from the invention. Accordingly, the invention is not limited except as by the appended claims.

I/We claim:

1. A computer-implemented method for searching a plurality of items via a mobile device, wherein individual items of the plurality of items are characterized by Japanese text portions, the computer-implemented method comprising:
receiving a search query on a mobile device to identify an item characterized by Japanese text;
generating a text search term based on the received search query;
determining a plurality of matching items from a set of items based on the text search term, wherein each of the plurality of matching items includes a Japanese text portion having matching text corresponding to the text search term;
for each of the plurality of matching items:
determining a starting point within the Japanese text portion;
determining a position of the matching text relative to the starting point; and
determining a priority order of the matching item in the plurality of matching items based on the determined position relative to the starting point; and
providing a list of matching items that are ordered based on the determined priority order.

2. The computer-implemented method of claim 1, wherein the set of items includes at least one of: a media file, an address book entry, a document file, or an application.

3. The computer-implemented method of claim 1, wherein determining the starting point comprises:
identifying a punctuation mark in the Japanese text portion; and
locating the starting point in proximity to the identified punctuation mark.

4. The computer-implemented method of claim 1, wherein determining the starting point comprises:
identifying a change in alphabet in the Japanese text portion; and
locating the starting point at the identified change in alphabet.

5. The computer-implemented method of claim 1, wherein determining the starting point comprises:
identifying a character string having a format of a phone number in the Japanese text portion; and
locating the starting point in proximity to the identified character string.

6. The computer-implemented method of claim 1, wherein determining the priority order comprises:
calculating a character-count distance from the matching text to the nearest starting point before the matching text; and
determining the priority order based on the calculated character-count distance.

7. The computer-implemented method of claim 1, wherein determining the priority order further comprises assigning a higher priority to a matching item if the matching text is at the beginning of the Japanese text portion.

8. The method of claim 1, wherein determining the starting point further comprises determining a first starting point and a second starting point within the Japanese text portion and wherein determining the priority order further comprises assigning a higher priority to the matching item if the matching text includes all of the text between the first starting point and the second starting point.

9. A system for searching a plurality of items from a mobile device, the system comprising:
a conversion component configured to generate a search term based on a user search query;
a search component configured to locate a plurality of matching items accessible via the mobile device based on the generated search term, each of the plurality of matched items including a text field containing matching Japanese text that corresponds to the search term;
a starting point determination component configured to determine a starting point in the text field of each of the plurality of matching items;
a distance calculation component configured to calculate a distance between the determined starting point and the matching Japanese text for each of the plurality of matching items; and
an ordering component configured to determine an order of the plurality of matching items based on the calculated distances and output at least some of the plurality of matching items to a user based on the determined order.

10. The system of claim 9, wherein the plurality of matching items includes at least one of: a media file, an address book entry, a document file, an image file, or an application.

11. The system of claim 9, wherein the starting point determination component is configured to determine the starting point by:
identifying a punctuation mark in the text field; and
locating the starting point in proximity to the identified punctuation mark.

12. The system of claim 9, wherein the starting point determination component is configured to determine the starting point by:
identifying a change in alphabet in the text field; and
locating the starting point at the identified change in alphabet.

13. The system of claim 9, wherein the starting point determination component is configured to determine the starting point by:
identifying a string indicative of a phone number in the text field; and
locating the starting point in proximity to the identified string.

14. The system of claim 9, wherein the ordering component is configured to determine the order by:
calculating a character-count distance from the matching text to the nearest starting point before the matching text; and
determining the priority order based on the calculated character-count distance.

15. The system of claim 9, wherein determining the order further comprises assigning a higher priority to a matching item if the matching Japanese text is at the beginning of the text field.

16. A computer-readable storage medium containing instructions for controlling a mobile device processor to search among a set of items accessible via the mobile device, wherein an individual item of the set of items is characterized by Japanese text, by a method comprising:
receiving a search query on the mobile device to identify an item characterized by Japanese text;
generating a text search term based on the received search query;
determining a plurality of matching items from the set of items based on the text search term, wherein each of the plurality of matching items includes a Japanese text portion having matching text corresponding to the text search term;
for each of the plurality of matching items:
determining a starting point within the Japanese text portion;
determining a position of the matching text relative to the starting point; and
determining a priority order of the matching item in the plurality of matching items based on the determined position relative to the starting point; and
providing a list of matching items that are ordered based on the determined priority order.

17. The computer-readable storage medium of claim 16, wherein the set of items includes at least one of: a media file, an address book entry, a document file, or an application.

18. The computer-readable storage medium of claim 16, wherein determining the starting point comprises:
identifying a punctuation mark in the Japanese text portion; and
locating the starting point in proximity to the identified punctuation mark.

19. The computer-readable storage medium of claim 16, wherein determining the starting point comprises:
identifying a change in alphabet in the Japanese text portion; and
locating the starting point at the identified change in alphabet.

20. The computer-readable storage medium of claim 16, wherein determining the starting point comprises:
identifying a character string having a format of a phone number in the Japanese text portion; and
locating the starting point in proximity to the identified character string.

21. The computer-readable storage medium of claim 16, wherein determining the priority order comprises:
calculating a character-count distance from the matching text to the nearest starting point before the matching text; and
determining the priority order based on the calculated character-count distance.

22. The computer-readable storage medium of claim 16, wherein determining the priority order further comprises assigning a higher priority to a matching item if the matching text is at the beginning of the Japanese text portion.

23. The computer-readable storage medium of claim 16, wherein determining the starting point further comprises determining a first starting point and a second starting point within the Japanese text portion and wherein determining the priority order further comprises assigning a higher priority to the matching item if the matching text includes all of the text between the first starting point and the second starting point.
